(19) United States
(12) Patent Application Publication
(10) Pub. No.: US 2004/0140258 A1
(43) Pub. Date: Jul. 22, 2004

(54) Valve in a filter

(75) Inventors: Herbert Jainek, Heilbronn (DE); Willy Holzwarth, Asperg (DE)

Correspondence Address: CROWELL & MORING LLP, INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/660,728

(22) Filed: Sep. 12, 2003

(30) Foreign Application Priority Data
Sep. 14, 2002 (DE) 102 42 872.7

(51) Int. Cl. B01D 35/00

(52) U.S. Cl. 210/418; 210/435; 137/455

(57) ABSTRACT

A valve in a filter having a valve body that is installed in a valve housing and is displaceable between a closed position and an open position. The valve housing has an elastically deformable clamping collar that protrudes radially in relation to its outer housing wall.

### BACKGROUND OF THE INVENTION

The present invention relates to a valve in a filter, particularly in a liquid filter, having a valve body that is installed in a valve housing and is displaceable between a closed position and an open position.

Valves of this type are used as safety or bypass valves in filters, e.g., for internal combustion engines, particularly in liquid filters in which the fluid to be filtered flows through a filter element disposed in a filter housing and is discharged again from the filtered fluid side of the filter element. Particularly if the filter element is dirty, the flow resistance through the filter element may become impermissibly high. This can result in a pressure buildup on the unfiltered side of the filter element and can destroy the filter element and possibly other components of the filter.

To prevent such destruction of the filter, the filters are provided with a safety valve that opens when a pressure limit is exceeded and connects the unfiltered side directly with the filtered side of the filter element. For cost reasons, such safety valves have a simple structure and usually comprise a valve body installed in a valve housing. The valve body on its one side is biased by a valve spring in its sealing position and on its other side is subject to the pressure of the fluid to be cleaned on the unfiltered side of the filter element. If the pressure exceeds the closing force of the valve spring, the valve body is moved to its open position and the fluid can flow away via the safety valve.

The valve housing in such safety valves of the prior art is usually made of aluminum and is installed in a press-fit in a receiving opening in the filter housing, which is usually also made of aluminum. Because the same material is selected for both the filter housing and the valve housing, the two components have the same thermal expansion coefficient, which avoids stresses due to thermal expansion differences. For cost reasons and to simplify production, however, it is desirable to make filter housings of synthetic resin material, i.e., plastic. Plastic housings, however, are not suitable to absorb the forces that are generated by a press-fit.

### SUMMARY OF THE INVENTION

Accordingly it is an object of the invention to provide an improved overpressure bypass valve for a filter.

Another object of the invention is to provide an overpressure bypass valve which is particularly suitable for use in a liquid filter.

A further object of the invention is to provide an overpressure bypass valve for a filter that has a simple structure and can be firmly anchored in the filter housing at low cost.

An additional object of the invention is to provide an overpressure bypass valve for a filter which is especially suitable for use in a synthetic resin (i.e., plastic) filter housing.

These and other objects are achieved in accordance with the present invention by providing a valve in a filter having a valve body that is installed in a valve housing and is displaceable between a closed position and an open position, wherein the valve housing comprises an elastically deformable clamping collar that protrudes radially relative to an outer housing wall and that is configured in such a way that a tangent lying in a longitudinal valve plane and applied to the outer clamping rim forms an angle of less than 90° with the longitudinal valve axis.

Advantageous refinements and preferred embodiments of the invention are described hereinafter.

The valve housing of the valve according to the invention has an elastically deformable clamping collar that protrudes radially relative to the outer housing wall and, in addition to this radial component, also rises above the outer housing wall in an axial component. This obliquely protruding clamping collar is configured in such a way that a tangent lying in a longitudinal valve plane and applied to the outer collar rim forms an angle with the longitudinal valve axis that does not exceed 90°. This ensures that the valve housing can be inserted into a recess in the filter housing in such a way that the clamping collar, during the insertion motion, because of its inherent elasticity, is initially radially compressed until the valve reaches its final seat, but can expand again once the final position is reached.

As the clamping collar expands, the valve is firmly clamped in place, such that, due to the elastic forces that cause the expansion, the clamping collar can claw into the surrounding wall. The valve is firmly fixed in its seat, so that an accidental loosening is practically excluded because of the interhooked position of the clamping collar.

In contrast to prior art designs, this is not a press fit, however, which is achieved by pressing an aluminum valve into an aluminum housing. Instead, because of the expansion of the clamping collar when the valve reaches its final seat, the clamping collar claws in or digs in along a circumferential line. As a result, this valve, which is advantageously made of sheet metal, is particularly suitable for use in plastic filter housings, where the plastic, which is softer than metal, facilitates the digging in of the clamping rim. Even if the housing that accommodates the valve or the valve itself expands as a result of heat, the clamping effect ensures a reliable seat.

If the clamping collar is disposed in the area of the axial end face and a shoulder that is axially recessed in relation to the end face, the valve housing can be inserted into the housing recess inside the filter with its axial end face, which is located opposite the collar, first. A clamping force exerted by the clamping collar is then applied only just before the valve reaches its final seat in the housing recess.

The clamping collar protrudes, for example, at a 45° angle from the lateral surface of the valve housing. The clamping collar preferably tapers but can also be outwardly convex to facilitate insertion into the recess or accommodation in the filter housing.

The clamping collar is preferably located in the area of an axial end face of the valve housing and forms an integral part with the valve housing. Parallel to the clamping collar and offset at a small axial distance therefrom, a circumferential shoulder may be provided on the lateral surface of the housing wall, such that the axial section between the clamping collar and the shoulder forms a groove to receive a gasket. Once the valve has been inserted, the clamping collar is radially compressed, so that the gasket, when inserted into the groove, is seated against the inner wall of the housing recess in the filter housing that accommodates the valve and can develop its sealing function. In one advantageous embodiment, this is further enhanced because the shoulder has a slightly smaller diameter than the unstressed clamping collar.

The valve housing, including the clamping collar, and possibly also the shoulder, is advantageously made of sheet metal. This inexpensive construction makes it possible to produce a sufficiently great clamping force that is directed radially outwardly through the clamping collar. When the valve is inserted into a plastic filter housing, thermal expansion in the housing wall play a smaller role than in the configurations of the prior art with aluminum housings. As a result, cost aspects can be given greater consideration when the material for the valve housing is selected.

A stamping burr created in the outer collar area during production of the clamping collar can be advantageously used by the clamping collar to dig into the surrounding wall of the housing recess when the valve reaches its final seat.

### BRIEF DESCRIPTION OF THE DRAWINGS

The invention will be described in further detail hereinafter with reference to illustrative preferred embodiments shown in the accompanying drawings in which:

FIG. 1 is a sectional view of a valve inserted into a recess in a filter housing, and

FIG. 2 is an enlarged detail view of the area of the wall of the valve housing fitting against the wall of the filter recess.

### DETAILED DESCRIPTION OF PREFERRED EMBODIMENTS

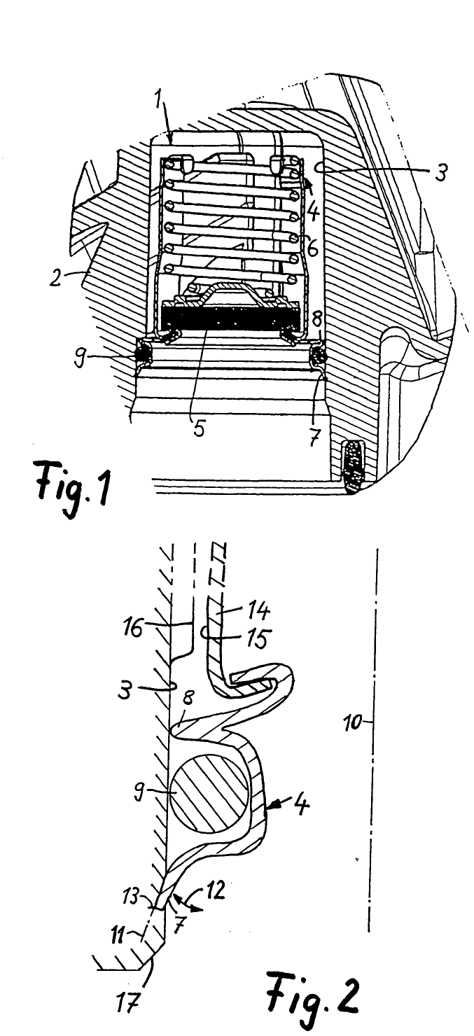

The valve 1 depicted in FIG. 1 is advantageously a safety valve that is installed in a recess 3 in a filter housing 2. The filter housing 2 forms part of a filter, particularly a liquid filter for a motor vehicle, e.g., for filtering fuel or transmission fluid or motor oil. Alternatively, it can also be used in an air filter.

The valve housing 4 of the valve 1 has a smaller diameter than the recess 3 in the filter housing 2 that receives the valve, so that the valve can be inserted into the recess with zero insertion force. Inside the valve housing 4 a valve body 5 is biased by a valve spring 6 in the direction of its closed position. The valve body 5 can be subject to axial pressure from the fluid to be filtered. If the pressure exerted by the fluid exceeds the force of the valve spring 6, the valve body 5 can be displaced axially in an upward direction into its open position against the force exerted on it by the valve spring 6.

The valve body 5 adjoins the open axial end face in the valve 1. In the area of this end face, a radially and axially protruding clamping collar 7 is formed as an integral part of the housing wall of the valve housing 4. This clamping collar forms part of the valve housing wall and protrudes radially and axially relative to the lateral surface of the valve housing 4. This clamping collar 7 can be elastically deformed within the bounds of its material elasticity and is radially compressed during insertion of the valve 1 into the recess 3 inside the filter housing 2.

The radial compression of the clamping collar causes a radially outwardly acting clamping force to be generated, which presses the outer clamping collar rim against the inner wall of the recess 3. Because the diameter of the valve housing 4 is smaller than the recess 3, the valve 1 can be easily inserted into the recess until it reaches its final seat. The necessary clamping force is applied by the clamping collar 7, which in its unstressed state has a larger diameter than the recess 3, so that the clamping force extends linearly across the circumference of the clamping collar.

If the material of the filter housing 2 is soft enough, the outer rim of the clamping collar 7 will dig into the inner wall of the recess because of the linear expansion of the clamping force, so that a barb-like positive fit can be realized between the clamping collar and the filter housing.

Parallel to and spaced an axial distance from the clamping collar 7, a circumferential shoulder 8 is formed on the valve housing 4, which also protrudes radially relative to the lateral surface of the valve housing 4. In the axial section between the clamping collar 7 and the shoulder 8, a circumferential groove is formed, into which a gasket 9 is inserted, which is preferably configured as an O-ring and can bridge any tolerances and thermal expansion differences between the housing and the valve.

As the enlarged detail of FIG. 2 shows, the clamping collar 7, which, due to its inherent elasticity can be pivoted in the direction indicated by arrow 12, is slightly convex but can also be purely conical. In relation to a longitudinal valve axis 10, a tangent 11 applied to the outer clamping collar rim and lying in a longitudinal valve plane that includes the longitudinal valve axis forms an angle ranging from 0° to 90° and, particularly when the valve is inserted, is e.g., approximately 30°. When the clamping collar 7 is unstressed, the angular range is between 10° and 45° and has a higher value than in the inserted state.

The valve housing 4 is made of two parts. It has a lower section on which the clamping collar 7 is formed, and a valve cover 14, which is placed on the lower section and is connected therewith via a flanged rim. The clamping collar 7 protrudes radially outwardly relative to the outer housing wall 15.

The outer clamping collar rim has a radially protruding stamping burr 13, which is created during production and can advantageously be used for digging into the wall in the filter housing 2. This increases the clamping force.

On the inner wall of the recess 3, a rib 16 is disposed, which forms a limit stop for the valve as it is inserted into the recess. In the end-face area of the recess 3, the recess is expanded via a bevel 17, so that the radially protruding clamping collar 7 is more easily compressed and can be better inserted. The gasket 9 can also be more easily inserted.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A valve in a filter having a valve body that is installed in a valve housing and is displaceable between a closed position and an open position, wherein the valve housing comprises an elastically deformable clamping collar that protrudes radially relative to an outer housing wall and that is configured in such a way that a tangent lying in a longitudinal valve plane and applied to the outer clamping rim forms an angle of less than 90° with the longitudinal valve axis.

2. A valve according to claim 1, wherein said valve is a liquid filter valve.

3. A valve according to claim 1, wherein the clamping collar is convex.

4. A valve according to claim 1, wherein the clamping collar is conical.

5. A valve according to claim 1, wherein the clamping collar is disposed in the area of an axial end face of the valve housing.

6. A valve according to claim 1, wherein a circumferential, radially protruding shoulder is disposed on the outer wall of the valve housing parallel to the clamping collar.

7. A valve according to claim 6, further comprising a gasket inserted into a circumferential groove formed axially between the clamping collar and the shoulder.

8. A valve according to claim 6, wherein the clamping collar has a larger diameter than the shoulder.

9. A valve according to claim 1, wherein the valve housing, including the clamping collar, is made of sheet metal.

10. A valve according to claim 1, wherein the clamping collar has a radially protruding stamping burr formed along an outer rim thereof.
